(19) United States
(12) Patent Application Publication
(10) Pub. No.: US 2010/0123908 A1
(43) Pub. Date: May 20, 2010

(54) SYSTEMS AND METHODS FOR VIEWING AND PRINTING DOCUMENTS INCLUDING ANIMATED CONTENT

(75) Inventors: Laurent Denoue, Palo Alto, CA (US); Scott Carter, Los Altos, CA (US); Gene Golovchinsky, Menlo Park, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/272,714

(22) Filed: Nov. 17, 2008

(51) Int. Cl. H04N 1/00; G06T 13/00

(52) U.S. Cl. 358/1.6; 345/475

(57) ABSTRACT

Most documents that are in use today embed or link to animated content. Presently, a large percentage of online content is hypertext markup language (HTML) and many HTML documents embed animations. The aforesaid online content is amenable to printing. However, embedding animated content in a document will lead to information loss when the document is printed. Users cannot print the animations or the videos embedded in documents. Therefore, there is provided a method and system for automatically finding animated content embedded in documents such as web pages, slide presentations, word processing documents, and PDF documents, that are being displayed to a user, replacing the animated content by a printable version, such as a keyframe, and a unique code, and assigning each animation a URL, to allow the users to retrieve the animations via a website on computer displays or mobile devices as they read the printed document.

### FIELD OF THE INVENTION

This invention generally relates to methods and systems for printing and presenting documents and, more particularly, to printing and presentation of documents that include animated content.

### BACKGROUND OF THE INVENTION

More and more of the documents that are available on the internet contain animations. For example, many tutorial pages on different websites are accompanied by short animations helping users to understand how a particular device works. Because a large part of the tutorial document is textual, it is likely that the user would print the document. On some occasions, users print pages or documents for archival purposes, fearing, for example, that the original online version might disappear, or for legal reasons. In addition to web documents, presentation slides, word processing documents and portable document format (PDF) documents can include animated content. Unfortunately, however, the animation effects included within the document cause potential problems when the document is printed. Additionally, the embedded animation may require extensive resources for being displayed that are not available on media display devices with limited presentation capabilities, such as mobile devices.

Assuming that the uniform resource locator (URL) was printed together with the document, as is often the case, the user could use an internet enabled device to re-access the online version of the document that included the animation. However, this would still require some effort to find the passage that contains the animation.

Presentation slides that are generated by computer presentation software and include animations present issues of their own. In a printed version of the document, the animations are printed on top of each other on one slide or otherwise appear chaotic. Software that is marketed for alleviating the issues with printing of animations creates formatting issue for the document itself. More recent versions of online presentation tools make it trivial for users to embed online videos in their presentations. In addition to animations, embedded short video clips of product or software demonstrations, or clips of conferences are becoming more and more common. Yet, conventional printing devices are unable to create a representation of this rich content.

One existing system provides a printed version of video content. This system provides a paper-based interface called video paper for interacting with a television broadcast or a recorded video and is disclosed in J. Graham and J. J. Hull, “Video Paper: A Paper-Based Interface for Skimming and Watching Video,” 2002 International Conference on Consumer Electronics, June 16-18, Los Angeles, Calif. The goal of video paper is to create a readable paper version of the multimedia content by following formatting guidelines designed for the newspaper industry. Video paper analyzes a video file and its goal is to extract important keyframes and text, from the frames through optical character recognition (OCR) or using speech-to-text or captioning, in order to build a document with these keyframes. A code is printed next to each keyframe, allowing users to quickly retrieve the corresponding section within the original video. As such, video paper uses paper as a navigational aid for skimming videos. This technology is disclosed exclusively in the context of television broadcasts or video recordings and does not pertain to documents available on websites, presentation slides, word processing documents, PDF documents or documents available in electronic books (e-books). Moreover, the entire document is a video file and the software need not locate the video clips from within a different file format.

Designated websites are available that store certain types of digital content accessible to a user. Bar codes are one conventional means of linking to digital content. Video paper, as well as some other conventional systems, use barcodes to link to digital artifacts. In video paper, a bar code is printed next to each extracted keyframe and the portion of the video starting from the keyframe may be accessed using this bar code. As another example, international standard book number (ISBN) codes for a book may be used to link to an on-line book seller's descriptions of that book. A digital video disk (DVD) bar code may be used to link to the Internet movie database (IMDB) web site. Some websites allow users to generate a PDF document containing a bar code and a thumbnail for a given video.

Certain conventional methods are available for removing the animated content before printing. For example, software tools are available for green printing that saves ink. The green printing software previews a printout and automatically removes contents that would waste ink, such as pages with few lines on them or pages that include large colored areas. There are software tools also available for removing advertisements from web documents before presenting the document to the viewer. There are websites that provide a registry of URLs to be blocked to the advertising removing software. Advertising removing software automatically removes advertisings from web pages by referring to the known list or the registry of source URLs of the advertisements.

In these conventional methods, however, the target material that is removed is either static or it is identified by referring to a pre-exiting list. Further, these conventional methods work only with web pages and are not usable for other types of documents such as word processing, slide presentation or PDF documents. Finally, these methods are concerned only with removing the target material, rather than saving or presenting them.

The above description addresses the difficulties associated with printing of animated content, including video content, embedded in various types of documents. Another problem with documents including animations is presentation of the document to a user irrespective of whether the document is being printed or not. For example, accessing a web page from a mobile phone might be quite slow or even impossible because the phone might not have the required rendering engines to view the animations within the page. As another example, in the case of documents presented to a user on an e-book, the current hardware of e-books does not allow for a fast refresh rate or audio playback. Therefore, the mere presentation of the animated content of the documents on these interfaces may cause problems.

### SUMMARY OF THE INVENTION

One problem associated with printing or presenting documents that contain animations, is that the animations are lost when the document is printed or when the device used for viewing the presentation does not have sufficient resources for rendering the animation. In such circumstances, systems and methods of the aspects of the present invention, identify the animation and replace the animation with a static substitute image. Users are provided with an option to retrieve the animation while reading the printouts. The animation is identified and removed from documents presented on a device of limited resources or replaced with a substitute including an identifier, in order not to slow down the display.

In one aspect, image analysis can be used to identify the corresponding animated content. For example, the substitute images or their features may be recorded as identifiers and relationships between the identifiers and corresponding animated contents may be recorded.

Aspects of the present invention provide a system and a method for automatically identifying embedded animations in documents, replacing the embedded animations with a substitute image, and providing the embedded animation to the user from a device with appropriate presentation capabilities.

In various aspects of the present invention, the documents including the embedded items may be web pages, slide presentations, word processing documents, PDF documents, and e-book documents.

In various aspects of the present invention, the embedded items may be flash animations, slide animations or build-ups, animated graphic interchange format (AGIF), video files, and links to embedded items such as a hyperlink to a multimedia embedded item in a word processing file.

Aspects of the present invention identify the embedded items by examining the scripting language used for development of the document being presented to the user after the document has been rendered for presentation to the user. Alternatively, aspects of the present invention identify the embedded items by grabbing a playable copy of the animated content directly from a stream generating the animated content or through screen playback of interactive animations.

Aspects of the present invention rank the embedded items, for being removed, based on embedded item properties such as nature, appearance, origin and pixel activity and the like. Nature indicates whether the embedded item is video or static, origin includes the referenced URL, appearance includes size such as aspect ratio, and position that may be at the margins of the document, and pixel activity indicates whether the user was interested in the animation or not. The extra Flash video (FLV) files loaded into a Shockwave Flash (SWF) embedded item are also ranked lower and are prime candidates for being removed.

Aspects of the present invention replace the embedded item with a substitute. The substitute may be a static image uniquely identifying the animation by containing a code, some metadata, and possibly a keyframe or other visual representation of the animation. According to aspects of the present invention, the substitute can be positioned at the same position and have the same size as the original, or can be placed elsewhere like in a margin.

Aspects of the present invention may provide the animated embedded item to the user upon receiving a prompt from the user or automatically. According to aspects of the present invention, the code provides a link to the original animation, to a cached copy, or to both. In other aspects of the invention, the animated embedded item may be transmitted to a user device, such as a personal digital assistant (PDA), the user mobile telephone, or to the user personal computer (PC). This transmission may be synchronous and simultaneous with the viewing of a print preview or with a printing of the document.

According to some aspects of the present invention, a print preview may be provided to a user that allows the user to modify the substitute, manually collate several slides, play a complex animation in place, select an alternate source for the embedded item, or use a special index page to list all the embedded items found in a document. Modifying the substitute may include trimming the animation or adjusting the resolution at which the animation is stored. Manually collating may include manually collating several slides from a slide-based presentation tool. Playing a complex animation may include playing a complex animation in place to be captured using screen capture. Selecting an alternate source for the embedded item may include keeping a desirable video.FLV file, as opposed to keeping the encompassing player.SWF and all the other files that are included in the player. The special index page may list all the embedded items found in a document with associated link and metadata information.

According to some aspects of the present invention, a service business could charge for content by archival time and by the amount of space being used to archive dynamic content associated with printed materials.

Aspects of the invention provide a method including obtaining a document, identifying animated content included in the document, replacing the animated content with a substitute, the substitute including an identifier identifying the animated content, providing the document including the substitute to a user on a first medium, and maintaining the animated content for display to the user, the display to the user being in response to provision of the identifier and in animated form at a second medium adapted for displaying animated content.

Aspects of the invention further provide a device including an input interface for receiving a document, one or more processors for identifying animated content included in the document and replacing the animated content with a substitute, the substitute including an identifier identifying the animated content, an output device for providing the document including the substitute to the user, and an output interface for providing the animated content to a storage medium, the storage medium maintaining the animated content for display to the user at a medium adapted for displaying animated content in response to provision of the identifier.

Aspects of the invention further provide a computer readable storage medium storing a program that when executed performs a method including obtaining a document, identifying animated content included in the document, replacing the animated content with a substitute, the substitute being a static image and including an identifier identifying the animated content, providing the document including the substitute to a user on a first medium, and maintaining the animated content for display to the user, the display to the user being in response to provision of the identifier and in animated form at a second medium adapted for displaying animated content.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows a flow chart for a method of identifying and removing or replacing an animated object or link with a static image, according to aspects of the present invention.

FIG. 2 shows a document page including an animation.

FIG. 3 shows a printout of the document page of FIG. 2 after the animation has been replaced with a static image, according to aspects of the present invention.

FIG. 4 shows an animated object replaced with a static image, according to aspects of the present invention.

FIG. 5 shows an animated object replaced with a cartoon-style rendering of the animation, according to aspects of the present invention.

FIG. 6 shows a print preview window identifying the animations in the pages of a document, according to aspects of the present invention.

FIG. 7 shows the retrieval of the animation of the FIG. 2 by referring to a website, according to aspects of the present invention.

FIG. 8 shows the retrieval of the animation on a screen of a mobile device, according to aspects of the present invention.

FIG. 9 shows the animation of FIG. 2 being played at the website, according to aspects of the present invention.

FIG. 10 shows a flowchart for a method of printing an animated embedded item, according to aspects of the present invention.

FIG. 11 shows a flowchart for a method of modifying a static substitute of an animation in a preview window, according to aspects of the present invention.

FIG. 12 illustrates an exemplary embodiment of a computer platform upon which the inventive system may be implemented.

### DETAILED DESCRIPTION

In the following detailed description, the term dynamic ink is used to generally refer to the methods and systems that incorporate aspects of the present invention.

In the following detailed description, reference will be made to the accompanying drawings, in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Aspects of the present invention provide a solution to a problem of printing or presenting a document including animated content by automatically finding the animated content embedded inside the document, removing this animated content or replacing it with a static image and a unique code, and creating an online version of the animated content that is accessible to readers of the paper document or the viewers of the presentation. The readers can access the animated content while reading the paper. The viewers who are viewing the document on a device with limited rendering capabilities will not be slowed down by the display of the animated embedded item. Instead, either the animated embedded item is removed altogether or the viewers are provided with a static image corresponding to the animated content.

The documents including the embedded items may be web pages, slide presentations, word processing documents, PDF documents, and e-book documents.

The animated and moving content may be embedded in the document may be flash animations, slide animations or build-ups, or video files provided in file formats such as AGIF, FLV, SWF, AVI or MPEG. The animated content may be embedded content or a hyperlink.

Aspects of the present invention automatically detect the moving content and remove the moving content or replace the moving content with a static version. The static version may include a keyframe from the moving content or additional features. In selecting the keyframe, printability may be one consideration. For example, selection of the keyframe may take into account whether a color copier or a black and white copier is being used. A unique identification (ID) code may also be included with the static version. The unique ID provides a link to the animated content.

Aspects of the present invention enable a user to grab a playable copy of an animated content directly from a stream such as a FLV file, deliver video content over the internet, and display it through screen playback such as by using a SWF. Aspects of the present invention are adaptable to interactive animations.

One type of document that may include animated content is a web page. The solution provided by the aspects of the present invention is useful when printing web pages that include Flash movies and AGIFs. Without utilizing the aspects of the present invention, a user has to use an internet enabled device to re-access the online version by inputting the URL and then still expend some effort to find the passage that contains the animation. With the aspects of the present invention, as the user reads the printout and sees an ID code associated with a static picture, he can access a designated website and enter the code to view the corresponding animation. Alternatives to typing codes include scanning bar codes, quick recognition (QR) codes, OCR scanned text, and the like. If the site is accessed from a mobile phone, the server at the designated website serves the animation properly formatted for the mobile phone. For example, the animation would be shown as an AGIF for wireless application protocol (WAP) phones.

Another type of document that may include animated content is a slide presentation that may be generated by an online presentation tool or a stand alone presentation software. Online presentation tools make it trivial for users to embed online videos in their presentations. In addition to animations, embedded short video clips of product or software demonstrations, or clips of conferences are becoming more and more common. With aspects of the present invention, printing rich animations is possible and safe. Like paper, the aspects of the present invention provide users with peace of mind. The servers of the aspects of the present invention may link the ID code to the original URL, but they are also capable of copying the material for long term archival. A service business that provides an archiving service could charge for content by archival time and by the amount of space being used to archive dynamic content associated with printed materials.

Another type of document that may include animated content is the document shown on e-books. E-books can benefit from the technology of the aspects of the present invention because it may be possible for readers of e-books to click on the code links to cause a different display, for example a desktop computer, to show the linked dynamic content.

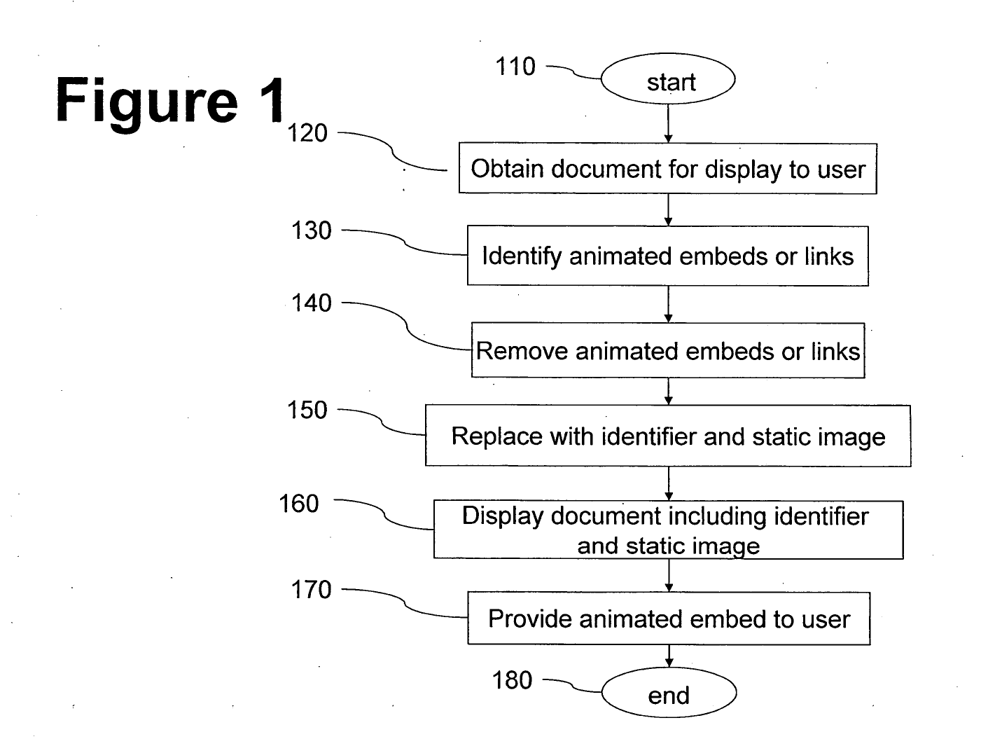

FIG. 1 shows a flow chart for a method of identifying and removing or replacing an animated object or link with a static image, according to aspects of the present invention.

The method begins at 110. At 120, a document is obtained and may be rendered for being displayed to a user. At 130 animated embedded items and/or links are identified in the document being displayed to the user. At 140, the animated embedded items and/or links are removed or lifted from the document. At 150, the lifted embedded item or link may be replaced by an identifier and a static image, corresponding to the lifted embedded item, in a preview version of the document being displayed to the user. At 160, the document including the identifier and the static image is displayed to the user. At 170, the animated embedded item or an animation corresponding to the link is provided to the user on a suitable device. At 180, the method ends. Replacing the embedded item or the link at 150 and providing the animated embedded item to the user at 170 are optional. The method may end after identifying 130 and removing 140 the embedded item or the link.

Aspects of the present invention, at 120, obtain and may render a document for being displayed to the user. Four types of documents including embedded content are discussed as examples. These examples include web page documents, slide presentation documents, word processing documents, and PDF documents. Other similar types of documents may be processed by aspects of the present invention. Alternatively, aspects of the present invention identify the embedded items by grabbing a playable copy of the animated content directly from a stream generating the animated content without having had to render the document for display.

Aspects of the present invention, next at 130, find or identify the animated content or find links to animated content in a document that is being presented to a viewer or a user. Two methods of detecting the embedded animations, including movies and links, are provided. For some types of documents, the document object model (DOM) is used to identify embedded animations and links. For other types of documents where the animation to be indexed is in doubt, aspects of the invention provide the option of observing the user and recording the screen shots viewed by the user.

DOM is a platform- and language-independent standard object model for representing HTML or extensible markup language (XML) and related formats. A web browser is not obliged to use DOM in order to render an HTML document. However, the DOM is required by JavaScript scripts that wish to inspect or modify a web page dynamically. In other words, the DOM is the way JavaScript sees its containing HTML page and browser state.

According to one aspect of the present invention, a system for web pages is provided that automatically finds embedded Flash animations and AGIFs by navigating the DOM of the page. For slide presentations, automation is used to query the slide presentation document DOM to extract locations and links to animations and videos. Unlike web pages, these objects, namely the animations and videos, are typically not stored online. Therefore, they can be uploaded to a server. Each company can install its own servers or a server at central location can be used that is available through a web site.

Certain documents that are in PDF format may also include embedded SWF. Aspects of the present invention are also adapted to detecting these embedded items and replacing them with static pictures when the document is printed or being viewed on a device of limited capabilities.

Aspects of the present invention are also able to identify links to animations from within the document. For example, users may provide links pointing to video files in business and scientific papers by providing reference URLs. The aspects of the system and the method of the present invention treat these links as embedded animations.

Sometimes, automatic detection can fail to capture the object correctly. For example, Flash animations can often load external movies at runtime, so capturing the initial SWF file would be pointless. For these types of objects, aspects of the present invention provide the users with the choice to play the animation in place, and the system of the present invention records the screen pixels as well as the audio while the animation plays out. This aspect of the present invention is applicable, for example, to a Flash animation requiring button clicks. This aspect of the invention observes the user screen and as such gives the user control to determine which animation is going to be indexed for storing or viewing on a different website. Therefore, if the system and method of the present invention have any doubts as to which animation to index, they select the animation that was watched by the user.

After identifying the animated content, that includes different types of embedded items and links, at 140, aspects of the present invention remove the animated content. Removal is carried out in a non-obtrusive way such that original layout of the document is not disturbed and the paragraphs and line breaks remain as they were. Accessing the DOM, as explained above, provides access to exactly the animated portions that are to be removed or replaced. For some documents, however, accessing DOM is not sufficient and a play in place of the animation is used, as also explained above.

Aspects of the present invention at 150 replace some or all of the animated content with an identifier identifying the animated content and a static image. The static image may be the starting frame, the middle frame or some other keyframe of the animation or a motion blur. Some content, such as ads, is removed without being replaced. At 160, the document is now shown and displayed to the user with the animated content being replaced with the static image.

As for providing the animated embedded item to the user at 170, the animated embedded item may be provided elsewhere on a different server; the animated embedded item may be provided to the user by storing and providing a link to the original file, the animated embedded item may be saved in a copy at the server where the user is, or it may be transcoded and available as a different file. The animated content is provided to user in response to provision of the identifier by the user.

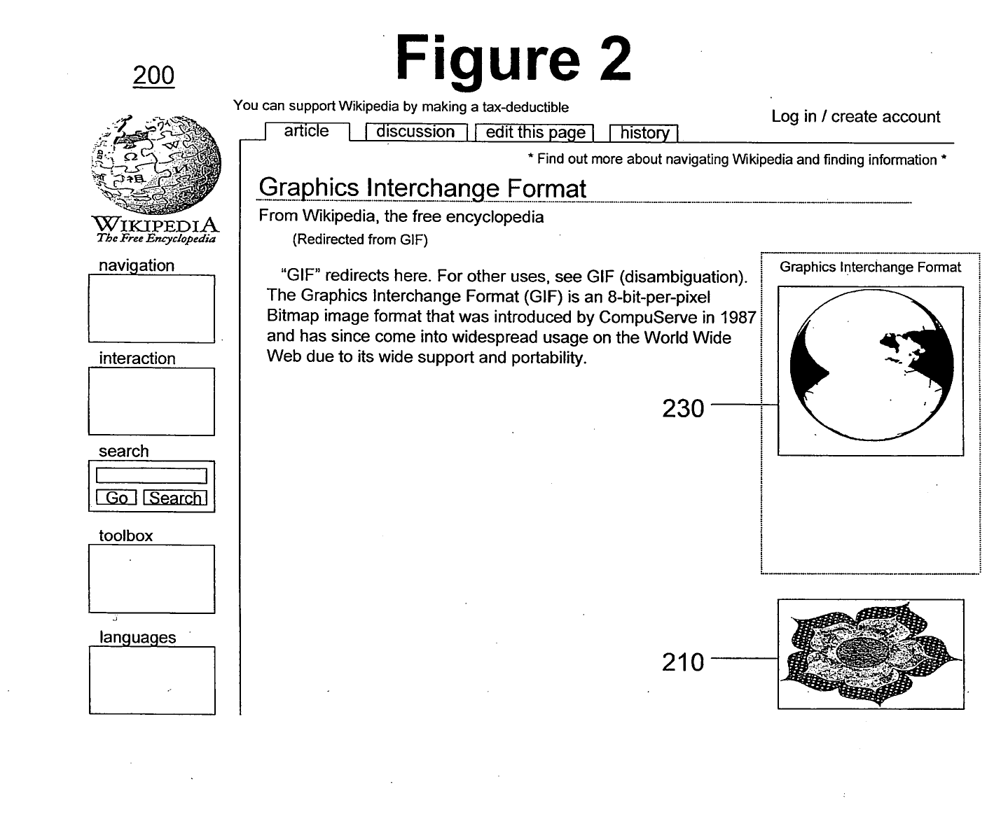

FIG. 2 shows a document page including an animation. A document 200 is shown before being printed or before being processed such that the animated content is replaced with a static image. The document 200 includes a stationary image 210 and an animated image 230.

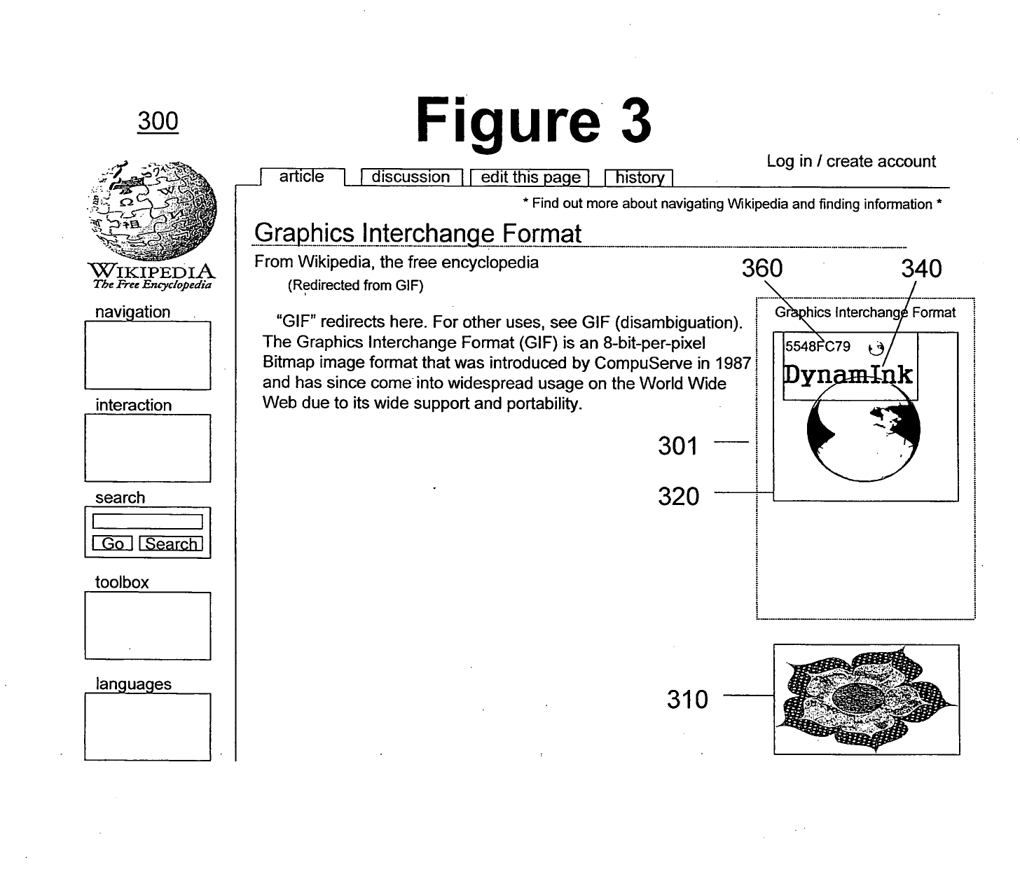

FIG. 3 shows a printout of the document page of FIG. 2 after the animation has been replaced with a static image, according to aspects of the present invention.

A printout 300 of the document 200 is shown. The image 300 may also be a print preview presented to the user before printing. The static image 210 is printed as the image 310. The animated image 230 is printed as an image 301 including a keyframe 320, a logo 340 and a code 360. The logo is used to signify the systems and the methods of the aspects of the invention, as appropriate in each context.

For example, when the images 210, 230 are in GIF format, after dynamic ink operates on the printed copy, the AGIF 230 is replaced with a static picture 301. The second GIF 210 is not replaced because the system identifies it as a normal and non-animated GIF.

In slide presentations, many users use several slides to build up an animation. These built up animations are effective when displayed on a screen during a presentation, but look poor and waste paper once printed, because each slide is basically the same as the previous, except with new objects added, removed or moved. Aspects of the present invention, as described in the context of print preview, allow users to manually collapse several slides into one page and automatically create a cartoon for these slides.

Aspects of the present invention are directed to substituting an animation with a static image or margin links. Aspects of the present invention also offer the option to substitute static pictures with other static pictures. This is useful when users print color documents on black and white printers. They can save ink by printing the picture in black and white while giving the readers the possibility to access the full color version. This is similar to what book publishers traditionally do with color plates inserted between otherwise black and white pages.

The size of embedded items is also kept and used to automatically or semi-automatically, through a print preview feature, decide whether or not to keep the embedded item. For example, very small images are often used by web designers to adjust the page layout or to add a tiny animated illustration. These types of embedded items can safely be removed from the list of embedded items used by dynamic ink based on their size. The location of the embedded item may be used as one criteria for removing or replacing the embedded item. For example, many ads on web pages are displayed as vertical or horizontal banners. The location of these ads is used as one indicator of the higher likelihood that they are a type of embedded item that must be removed.

Once an animation is identified and its position and size are determined, dynamic ink replaces the animation with a static picture and an associated unique code. In this process the original document does not have to be tampered with. The system and method of the present invention can either copy the original document or remember the substitutions so that the original version of the document is reconstituted after printing.

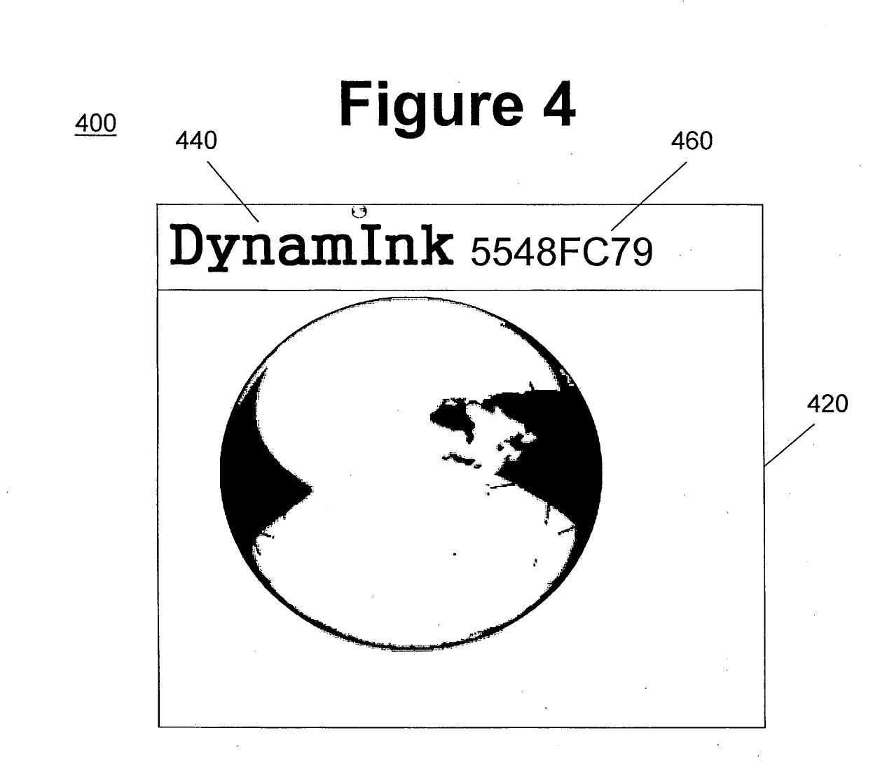

FIG. 4 shows an animated object replaced with a static image, according to aspects of the present invention.

A static image 400 is shown that is used by the aspects of the present invention to replace an animated object in a document. The animated object may be in GIF format, for example. The exemplary static image 400, replacing the animated object, includes a keyframe 420 from the animated object, a logo 440 and a unique code 460. The animated object, that is replaced by the static image 400, is an embedded item in the document and the unique code 460 may be calculated from the original URL of the embedded item.

The animated object may be replaced by the image with or without the unique code 460. The image can display this code 460 in a number of ways, such as raw characters as shown. However, machine readable codes that would make it faster for users equipped with appropriate hardware, such as a cell-phone with a camera, to be able to scan the codes may also be used. Other layouts can be used, such as adding the code 460 and the logo 440 at the bottom, top, left, or right of the keyframe 420, not including the logo in the image 400, and the like.

In one aspect of the present invention, the image 400 can contain a picture extracted from the animation, like the first or middle frames that are used in popular video sites. In other aspects, the picture or image 400 could be more complex, such as a series of key frames, or a static rendering of the animation. The keyframe 420 can also be chosen for its printability and estimated print quality. For example, selection of the keyframe may take into account whether a color copier or a black and white copier is being used. As for taking print quality into consideration, bright frames may be favored over very dark frames. More sophisticated substitutes can be used to represent the animation as shown below.

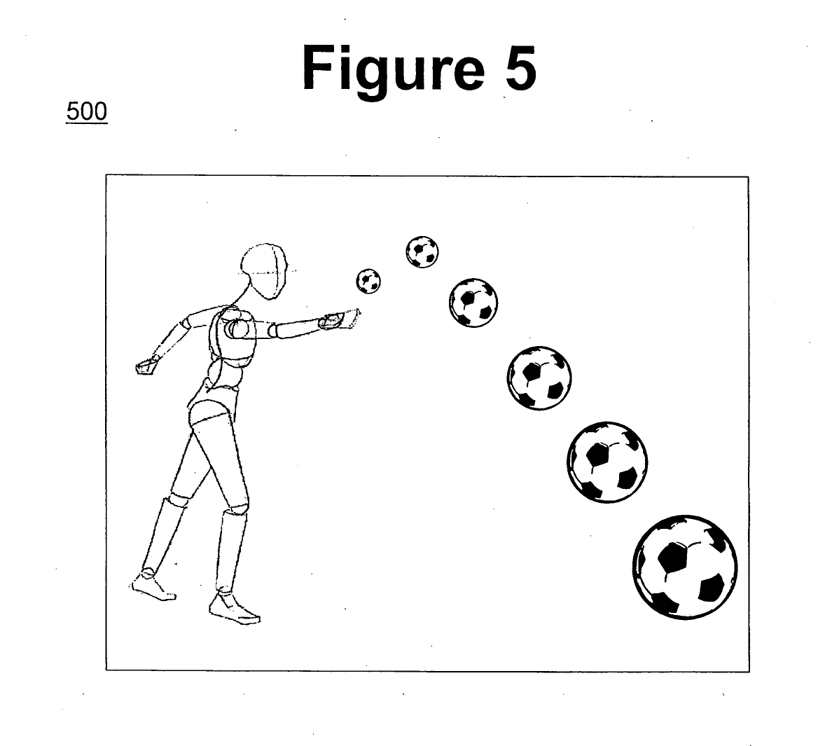

FIG. 5 shows an animated object replaced with a cartoon-style rendering of the animation, according to aspects of the present invention.

A static image 500 is shown which is a cartoon-style rendering of the animated content or animation that was present in the original document. The motion blur or cartoon shown in FIG. 5 summarizes the video sequence as one picture to show that there was motion. Other techniques that provide a single image to replace the animation may be used as well.

The image 400, 500 can also overlay the duration of the animation, and whether or not it contains an audio track. At retrieval time, the user could specify what track he would like to retrieve. For example, the user could specify whether he would like to retrieve the audio track only or the video track only.

If the user prints on a black and white printer, the image can also be automatically processed to grayscale so that it is more legible once printed.

When a document initially includes an embedded link to an animation, for example a hyperlink to a .mov file in a word processing document, the hyperlink can be placed in the margin of the document. A link placed in the margin does not disrupt the original layout of the document.

The .mov file format functions as a multimedia container file that contains one or more tracks, each of which stores a particular type of data: audio, video, effects, or text. Each track either contains a digitally-encoded media stream or a data reference to the media stream located in another file.

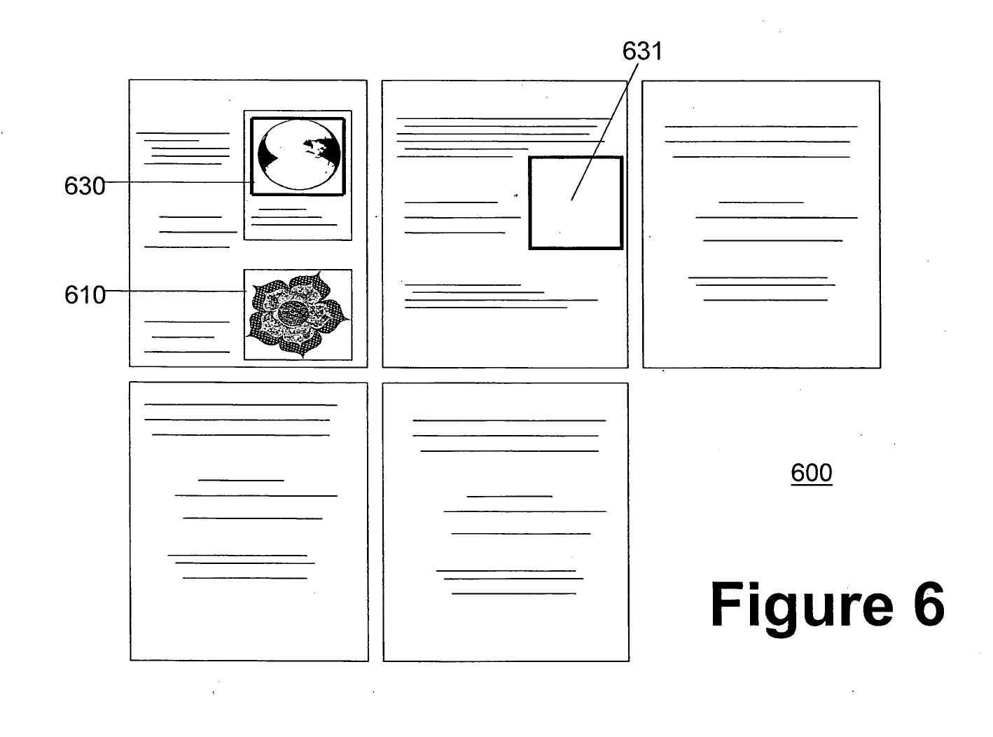

FIG. 6 shows a print preview window identifying the animations in the pages of a document, according to aspects of the present invention.

After embedded items have been detected, the system can automatically print, but a print preview can also be shown to the user. FIG. 6 shows a print preview 600 of a document that includes a stationary image 610 and animations 630, 631. The animations 630, 631 are shown in the print preview 600 using frames. The color of the frame corresponding to the location of the animation 630, 631 may be different or, as shown in FIG. 6, the frame may appear with a thicker circumference. In one situation, the animation 630 is replaced by a static image. In another situation, the animation 631 is removed and the modified appearance of the frame indicates that there had been an animation in the location where the modified frame appears.

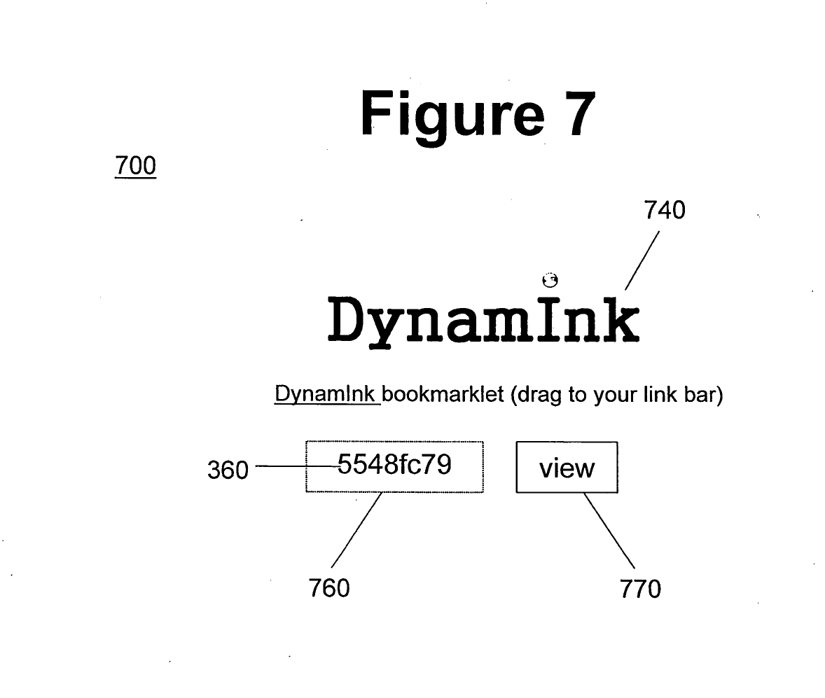

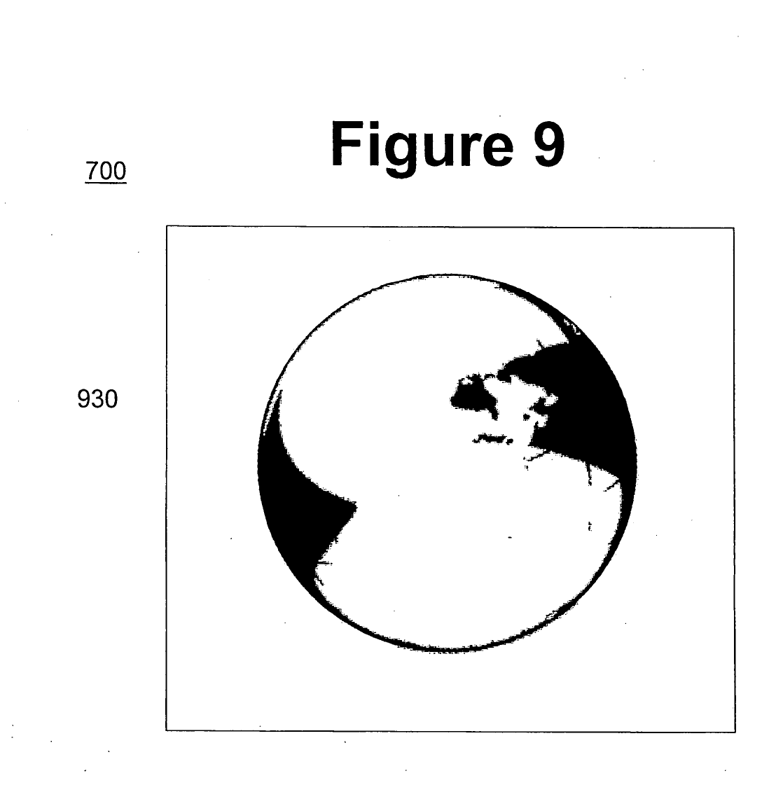

FIG. 2, FIG. 3, FIG. 7 and FIG. 9 are used to show a sequence of events for accessing an animated object in a printout. These drawings show an exemplary system, according to aspects of the invention, that is able to automatically find embedded flash animations and AGIFs. This exemplary system dynamically replaces embedded AGIFs with a picture that contains a unique code calculated from the URL of the original embedded item, as well as a logo and the first frame found in the animation.

FIG. 7 shows the retrieval of the animation of the FIG. 2 by referring to a website, according to aspects of the present invention.

A view of the website 700 is shown where the logo 740 appears in the window indicating the website. The code 360 of FIG. 3 is entered or dragged into a space 760. A view button 770 also appears on the website 700. Once the view button 770 is pressed or clicked upon, the website displays the animated object as shown in FIG. 9.

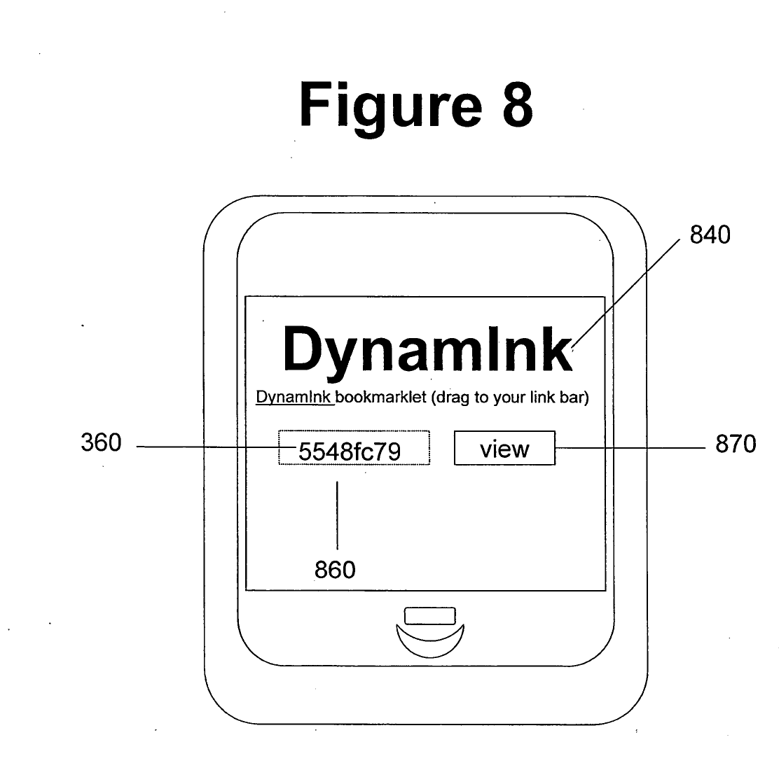

FIG. 8 shows the retrieval of the animation on a screen of a mobile device, according to aspects of the present invention.

A view of the website 800 is shown where the logo 840 appears in the window indicating the website. The code 360 of FIG. 3 is entered or dragged into a space 860. A view button 870 also appears on the website 800. Once the view button 870 is pressed or clicked upon, the website displays the animated object as shown in FIG. 9.

FIG. 9 shows the animation of FIG. 2 being played at the website, according to aspects of the present invention.

Another view of the website 700 is shown after a user has activated the view button 770. The animated image 230 of FIG. 2 is shown in an animated form 930 to the user on the website 700. This same image may be shown on the screen of the mobile device of FIG. 8.

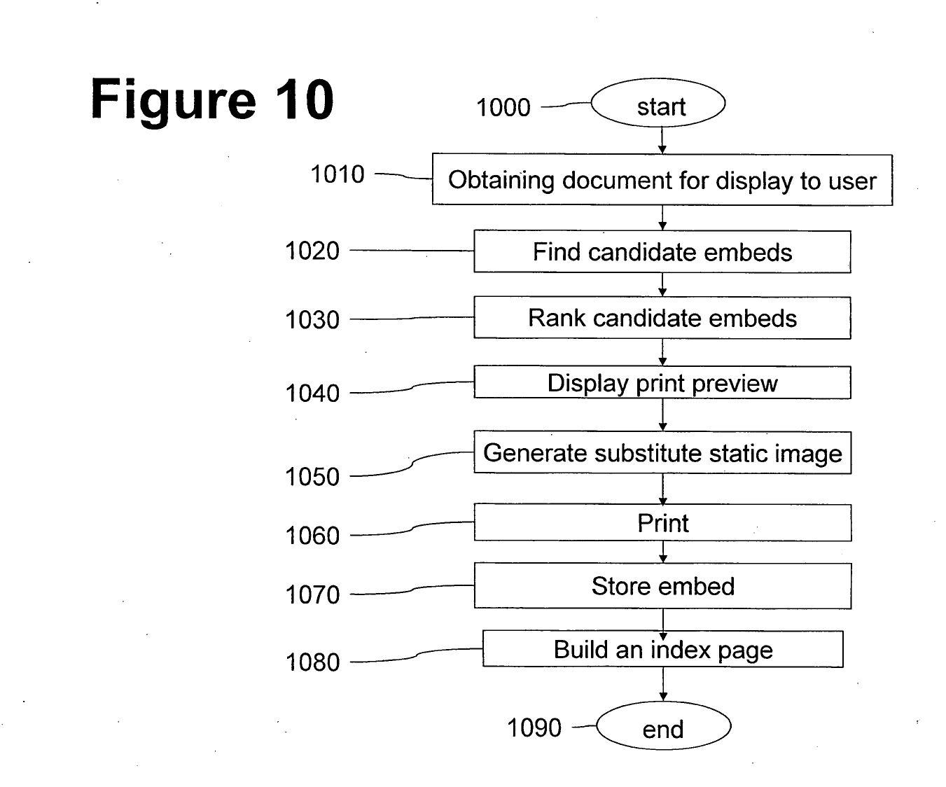

FIG. 10 shows a flowchart for a method of printing an animated embedded item, according to aspects of the present invention.

The method begins at 1000.

At 1010, a document including embedded items, such as animations, movies or links, is rendered for being presented and displayed to a user.

At 1020, the method finds candidate embedded items within the document being displayed to the user. The candidate embedded items include AGIFs, SWFs, animated buildups, videos and SWF embedded items. The method also finds links to known video formats such as AVI, MPEG and FLV.

At 1030, the method ranks the candidate embedded items that were found at 1020. The ranking of the candidate embedded items may be based on appearance, origin, or pixel activity. Appearance relates to aspect ratio, size or position. For example, the embedded items appearing as very tall or very wide are most likely ads. Embedded items originating from a website such as http://ads.doubleclick.com/ad1.swf are also likely to be ads. Pixel activity is an indicator of user actions. An embedded item that is clicked on by the user is higher ranked compared to an embedded item that is ignored. Ranking embedded items may also be based on duration. Lower ranked embedded items are those that will be removed and discarded. Higher ranked embedded items will be maintained for subsequent display to the user.

At 1040, the method shows a preview window of what will be printed. In the preview window, the embedded items may be ordered by rank. The preview window allows the user to play some embedded items in place for grabbing the embedded item through screen if the DOM method is not successful. The preview window shows the substitute static image. The static image may include an ID, a keyframe, and metadata that indicates the duration of the animation.

When multiple animations are present, the preview window allows the user to select which animation he wishes included and which should be excluded. This aspect operates similar to a manual override.

Some users build their own animation by duplicating a slide and a command such as by repeating the steps of move/add/remove objects a number of times. Some users use the features of slide presentation software to build an animation. In these situations, a regular printout overlaps all objects and is not usable. On the other hand, the preview window of the aspects of the present invention, allows users to manually collate several slides into a virtual animation. For example, the preview window brings up a viewer to play only those slides that contain native animations and screen-grabs into one virtual animation.

At 1050, the method generates a substitute static image to be printed on the printout. This image includes the ID and possibly metadata including information such as duration of the animation. A substitute can be overlaid over original object or placed somewhere else like in a margin of the document. For example, links to animated content may be placed in the margin of the printed document.

At 1060, the method proceeds to print the document including text and the generated substitute static image. In the case that the embedded animation is of the built up type, the printed version uses one sheet for all of the slides that make up an animation, thus saving paper.

At 1070, the embedded item is stored together with its associated ID and source. The embedded item may be stored at an online server, it may stay at its original source or it may be synchronized and delivered to the user device for his viewing. At this stage, the entire embedded animation may be saved or optionally the captured version may be saved instead of just the link to the source. When the entire embedded animation is stored, even if the URL is no longer there after a period of time, the document has been effectively printed for all intents and purposes and will be permanently available.

At 1080, the method builds an index page. The index page may list all embedded items found in the document with associated link and metadata information.

The method ends at 1090.

In an alternative aspect, the ID code associated with the saved animation is received at the website of the server that is saving the animations that have been printed by the method of FIG. 10 together with a decryption key. The ID code may be input manually by a user or scanned from the printout of the document including the animation. This step is carried out only if the animation is encrypted before being sent to the server that provides a playback of the animations. The decryption key may also be printed on the printout with the static image of the animation. When the server at the website receives a command to display the animation, the animation is displayed to the user after being decrypted.

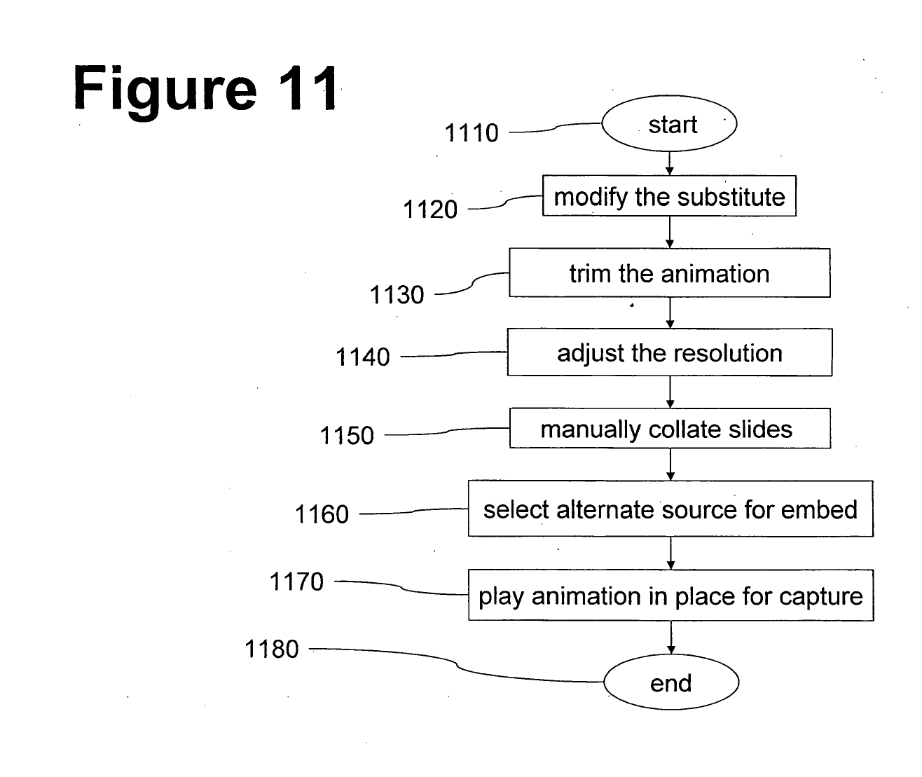

FIG. 11 shows a flowchart for a method for modifying a static substitute of an animation in a preview window, according to aspects of the present invention.

Various operations undertaken by a user when viewing a static substitute of an animated embedded item in a preview window are shown. Steps of this flow chart may be undertaken in an order other than the one showed. Some steps may be omitted. This flow chart is effectively a list of possibilities for a user to modify a print preview.

At 1110, the method begins.

At 1120, the user is permitted to modify the substitute.

At 1130, the user is permitted to trim the animation.

At 1140, the user is permitted to adjust the resolution at which the animation is stored online.

At 1150, the user is permitted to manually collate several slides from a slide-based presentation tool.

At 1160, the user selects an alternate source for the embedded item. For example, the user may keep video.FLV, instead of player.SWF.

At 1170, the user is permitted to play a complex animation in place to be captured using screen capture. This method is used when the animation is not easy to detect based on its format or source.

At 1180, the method ends.

Like a traditional print preview, the dynamic ink preview displays each page as an image, allowing users to have an overview of the printing pages. However, in a dynamic ink print preview, detected embedded items can be selected for further editing. Further editing includes selecting a different keyframe from the animation, trimming the animations, keeping or discarding the audio tracks, type of archival and dynamic ink resolution or dots per inch (DPI).

Trimming the animations would keep less than the original length. Regarding editing to keep or discard the audio tracks, the default may be set as keeping the audio tracks. The type of archival includes simply linking to the original object or uploading a copy of the object. Uploading a copy of the object may be set as the default for embedded items found in slide presentation and word processing files. To save bandwidth and time, users can choose to distill their animations to lower resolutions.

Aspect of the present invention relate to printing of the document as well. Once modified, the document can be printed using the standard mechanisms in place. A special index page can also be added to list all embedded animations that are available in the document, providing users with a quick way to scan through animations. The page numbers can also be shown.

The video summarization and keyframe extraction provide intelligent content capture, content adaptation and document layout analysis. Content adaptation includes taking into account low-bandwidth, frame rate adaptation, and image quality. Document layout analysis causes a segment web page to be displayed on the screen into pages.

Aspects of the present invention can also show users alternate sources. For example, embedded items on some web sites have a corresponding .FLV file. Dynamic ink offers users the choice to grab the FLV instead of the SWF that the player uses. This can be done using the source, or by observing the nature of the streams that are dynamically loaded by this object. When a specific animation has more than one external object, dynamic ink automatically ranks these external objects by likelihood of being the stream to be captured. For example, when a video player can load two other SWFs and one FLV, the FLV will be listed first. The ranking also takes into account the size of the element, for example 4×3 pixel FLV files will be listed after the main FLV that is 640×480. The source of the animated file may be used to rank the animation as well. If the source relates to an ad website, the animation is ranked lower.

Aspect of the present invention relate to security aspects as well. Although not central to this invention, an animation can be sent in an encrypted form to dynamic ink servers. The decryption key could be printed on the pages of the document. This solution is not less secure than printing documents. To view an animation, the user would again request the animation with the code, but the player in his device would prompt for the decryption key, allowing the content to be decrypted and printed. This solution, while requiring a special player in the device, has the advantage that the animations can safely be stored onto non-trusted servers. For example, employees of one establishment could safely print their animations onto dynamic ink servers of a second establishment without risking the second establishment to decrypt the files. This feature makes it possible to run a dynamic ink service business that assures content security. While anyone possessing the printout can retrieve the associated media, a third party cannot retrieve content by simply providing the access code when he is not in possession of the decryption key as well.

Detecting embedded animations is not perfect, especially for new SWF animations that rely on Actionscript to dynamically load external movie clips. In these situations, for example, the initial SWF is a loader, and the actual content is loaded dynamically. Aspects of the present invention provide the users with choices. For example, an AGIF may be represented using a cartoon-like rendering without much loss of information.

Aspects of the present invention may be used by printing companies by enabling them to participate in the era of digital documents. The printing companies can offer a seamless solution to their users for merging the perfection of the printed text and the advantages of moving imagery and audio.

Aspects of the present invention lead to more direct revenue from printing because users who did not print their documents because they felt the document would look bad once printed, or lose content can do so using the aspects of the invention. This is especially relevant for web pages that are more likely to embed animations in the first place. Readership of web pages surpasses many times the readership of other document types. Popular search engine indices contain less than 1% documents such as PDF, DOC, PPT, and the like; the remaining 99% are web pages.

Pinter machine manufacturers would benefit from the aspects of the present invention. Dynamic ink helps a printer manufacturer to transition from ink to pixel while still remaining connected to its core competency of printing documents. At the same time, the printer manufacturer is aware that users' needs have evolved and the documents are now multimedia.

Media companies may also benefit from the aspects of the present invention. Online newspapers that intend to provide a “Print Article” button may use the aspects of the invention for their animated content.

Web browsers, slide presentation software and portable document format software that include an embedding functionality in their applications may use this feature. Webmasters who wish to provide a print button to their users may also benefit from the aspects of the present invention. Companies that include online presentation tool suites may also benefit from the aspects of the present invention.

Aspects of the present invention also provide an opportunity to grow an online service for storing the printed animations and an opportunity to showcase and use its multimedia technology.

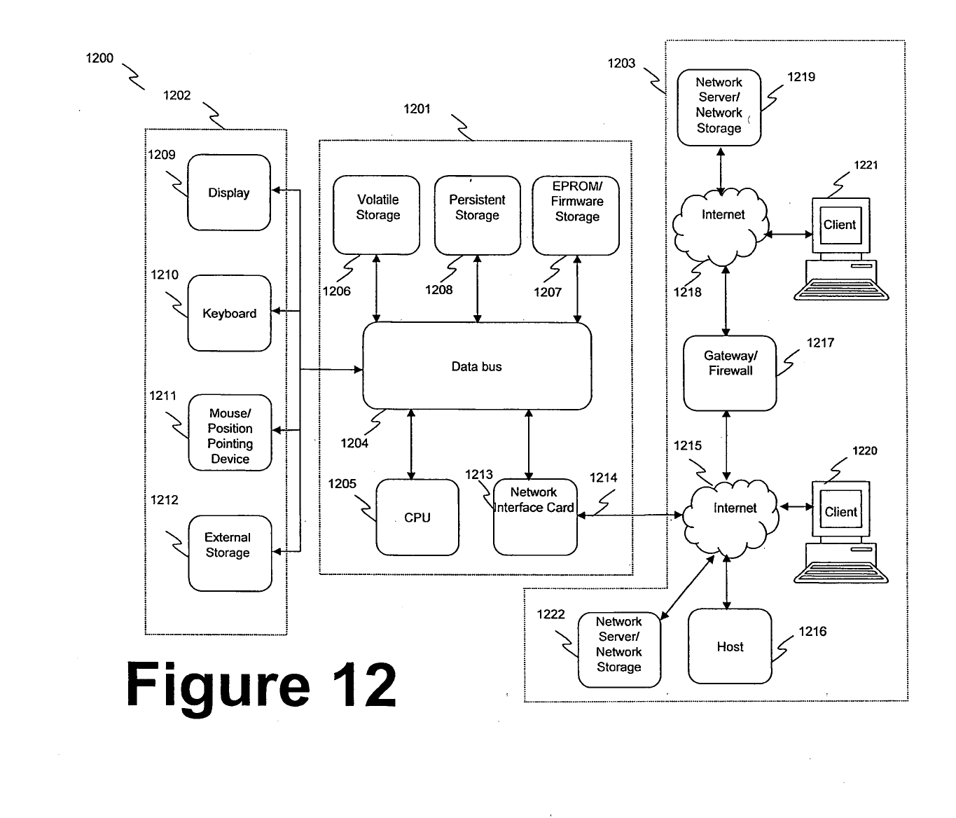

FIG. 12 is a block diagram that illustrates an embodiment of a computer/server system 1200 upon which an embodiment of the inventive methodology may be implemented.

The system 1200 includes a computer/server platform 1201, peripheral devices 1202 and network resources 1203.

The computer platform 1201 may include a data bus 1204 or other communication mechanism for communicating information across and among various parts of the computer platform 1201, and a processor 1205 coupled with bus 1201 for processing information and performing other computational and control tasks. Computer platform 1201 also includes a volatile storage 1206, such as a random access memory (RAM) or other dynamic storage device, coupled to bus 1204 for storing various information as well as instructions to be executed by processor 1205. The volatile storage 1206 also may be used for storing temporary variables or other intermediate information during execution of instructions by processor 1205. Computer platform 1201 may further include a read only memory (ROM or EPROM) 1207 or other static storage device coupled to bus 1204 for storing static information and instructions for processor 1205, such as basic input-output system (BIOS), as well as various system configuration parameters. A persistent storage device 1208, such as a magnetic disk, optical disk, or solid-state flash memory device is provided and coupled to bus 1201 for storing information and instructions.

Computer platform 1201 may be coupled via bus 1204 to a display 1209, such as a cathode ray tube (CRT), plasma display, or a liquid crystal display (LCD), for displaying information to a system administrator or user of the computer platform 1201. An input device 1210, including alphanumeric and other keys, is coupled to bus 1201 for communicating information and command selections to processor 1205. Another type of user input device is cursor control device 1211, such as a mouse, a trackball, or cursor direction keys for communicating direction information and command selections to processor 1204 and for controlling cursor movement on display 1209. This input device typically has two degrees of freedom in two axes, a first axis (e.g., x) and a second axis (e.g., y), that allows the device to specify positions in a plane.

An external storage device 1212 may be connected to the computer platform 1201 via bus 1204 to provide an extra or removable storage capacity for the computer platform 1201. In an embodiment of the computer system 1200, the external removable storage device 1212 may be used to facilitate exchange of data with other computer systems.

The invention is related to the use of computer system 1200 for implementing the techniques described herein. In an embodiment, the inventive system may reside on a machine such as computer platform 1201. According to one embodiment of the invention, the techniques described herein are performed by computer system 1200 in response to processor 1205 executing one or more sequences of one or more instructions contained in the volatile memory 1206. Such instructions may be read into volatile memory 1206 from another computer-readable medium, such as persistent storage device 1208. Execution of the sequences of instructions contained in the volatile memory 1206 causes processor 1205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1205 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 1208. Volatile media includes dynamic memory, such as volatile storage 1206.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on the data bus 1204. The bus 1204 carries the data to the volatile storage 1206, from which processor 1205 retrieves and executes the instructions. The instructions received by the volatile memory 1206 may optionally be stored on persistent storage device 1208 either before or after execution by processor 1205. The instructions may also be downloaded into the computer platform 1201 via Internet using a variety of network data communication protocols well known in the art.

The computer platform 1201 also includes a communication interface, such as network interface card 1213 coupled to the data bus 1204. Communication interface 1213 provides a two-way data communication coupling to a network link 1214 that is connected to a local network 1215. For example, communication interface 1213 may be an integrated services digital network (ISDN) card or a modem to provide a data communication connection to a corresponding type of telephone line. As another example, communication interface 1213 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 1213 sends and receives electrical, electromagnetic or optical signals that carry digital data streams representing various types of information.

Network link 1213 typically provides data communication through one or more networks to other network resources. For example, network link 1214 may provide a connection through local network 1215 to a host computer 1216, or a network storage/server 1217. Additionally or alternatively, the network link 1213 may connect through gateway/firewall 1217 to the wide-area or global network 1218, such as an Internet. Thus, the computer platform 1201 can access network resources located anywhere on the Internet 1218, such as a remote network storage/server 1219. On the other hand, the computer platform 1201 may also be accessed by clients located anywhere on the local area network 1215 and/or the Internet 1218. The network clients 1220 and 1221 may themselves be implemented based on the computer platform similar to the platform 1201.

Local network 1215 and the Internet 1218 both use electrical, electromagnetic or optical signals that carry digital data streams. The signals through the various networks and the signals on network link 1214 and through communication interface 1213, which carry the digital data to and from computer platform 1201, are exemplary forms of carrier waves transporting the information.

Computer platform 1201 can send messages and receive data, including program code, through the variety of network(s) including Internet 1218 and LAN 1215, network link 1214 and communication interface 1213. In the Internet example, when the system 1201 acts as a network server, it might transmit a requested code or data for an application program running on client(s) 1220 and/or 1221 through Internet 1218, gateway/firewall 1217, local area network 1215 and communication interface 1213. Similarly, it may receive code from other network resources.

The received code may be executed by processor 1205 as it is received, and/or stored in persistent or volatile storage devices 1208 and 1206, respectively, or other non-volatile storage for later execution. In this manner, computer system 1201 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the inventive document display systems. It is intended that the specification and examples be considered as exemplary only, with a true scope and spirit of the invention being indicated by the following claims and their equivalents.

What is claimed is:

1. A method comprising:
obtaining a document;
identifying animated content included in the document;
replacing the animated content with a substitute, the substitute including an identifier identifying the animated content;
providing the document including the substitute to a user on a first medium; and
maintaining the animated content for display to the user, the display to the user being in response to provision of the identifier and in animated form at a second medium adapted for displaying animated content.

2. The method of claim 1, wherein the document is selected from a group consisting of a web page, a word processing document, a slide presentation document and a printable document format document.

3. The method of claim 1, wherein the animated content is selected from a group consisting of a video file, a build up animation and a hyperlink.

4. The method of claim 1, wherein the animated content is selected from a group consisting of a Flash animation, a slide presentation animation, a slide presentation build-up, an AGIF, a video file, a .FLV file, a .SWF file, and a link to moving content including hyperlink to a .mov in a word processing file or to a AVI file.

5. The method of claim 1, wherein the substitute includes a static image selected from a group consisting of a keyframe and a cartoon-style rendering of the animated content.

6. The method of claim 1, wherein the identifying comprises:
analyzing a document object model of the document.

7. The method of claim 1, wherein the identifying comprises:
playing the animated content for the user;
capturing screen pixels as the animated content is being played; and
capturing audio content as the animated content is being played.

8. The method of claim 1, wherein the animated content is maintained by grabbing a playable copy directly from a stream generating the animated content or through screen playback of interactive animations.

9. The method of claim 1, wherein the animated content is maintained at a location selected from a group consisting of an original location of the document, a server maintaining a copy of the animated content, and a server displaying the document to the user.

10. The method of claim 1, wherein the animated content is transmitted to a user device synchronously with the displaying of the document to the user.

11. The method of claim 1, further comprising:
displaying the animated content to the user at the second medium responsive to the provision of the identifier by the user.

12. The method of claim 1, wherein the document being displayed to the user including the substitute is a print preview, the method further comprising:
printing the print preview responsive to receiving a print command from the user.

13. The method of claim 1, further comprising:
listing all animated content embedded in the document in an index page together with corresponding links to the animated content and corresponding metadata information.

14. The method of claim 1, further comprising:
ranking the animated content based on animation properties including nature, appearance, origin and pixel activity,
wherein the nature includes static or animated nature,
wherein the appearance includes aspect ratio, size and position,
wherein the origin includes a referenced uniform resource locator, and
wherein the pixel activity includes user actions.

15. The method of claim 1, wherein the document being displayed to the user including the substitute is a print preview, the method further comprising one or more of the following steps:
modifying the substitute;
manually collating slides when the document is generated by a slide presentation tool;
playing a complex animation in place when the animated content is the complex animation;
selecting an alternate source for the animated content; and
using a special index page to list all animated content found in the document,
wherein the modifying the substitute includes trimming the animated content and adjusting a resolution at which the animated content is stored,
wherein the manually collating includes manually collating several slides from the document,
wherein the playing of the complex animation includes playing the animated content in place to be captured using screen capture, and
wherein the selecting of the alternate source for the animated content may include keeping a desirable video.FLV file, as opposed to keeping an encompassing player.SWF and all other files included in the player.SWF.

16. The method of claim 1, wherein obtaining a document includes rendering the document for being displayed to the user.

17. A device comprising:
an input interface for receiving a document;
one or more processors for:
identifying animated content included in the document; and
replacing the animated content with a substitute, the substitute including an identifier identifying the animated content;
an output device for providing the document including the substitute to the user; and
an output interface for providing the animated content to a storage medium, the storage medium maintaining the animated content for display to the user at a medium adapted for displaying animated content in response to provision of the identifier.

18. The device of claim 17, wherein the document being displayed to the user including the substitute is a print preview, the device further comprising:
a printer for printing the print preview responsive to receiving a print command from the user.

19. The device of claim 17, wherein the device is a mobile device.

20. The device of claim 19,
wherein the substitute includes a blank image or a static image, and
wherein the device includes the storage medium.

21. A computer readable storage medium storing a program that when executed performs a method comprising:
obtaining a document;
identifying animated content included in the document;
replacing the animated content with a substitute, the substitute being a static image and including an identifier identifying the animated content;
providing the document including the substitute to a user on a first medium; and
maintaining the animated content for display to the user, the display to the user being in response to provision of the identifier and in animated form at a second medium adapted for displaying animated content.
